(19) United States
(12) Patent Application Publication
(10) Pub. No.: US 2023/0230490 A1
(43) Pub. Date: Jul. 20, 2023

(54) SYSTEM AND METHOD FOR BETTER DETERMINING PATH PARAMETERS OF AIRCRAFTS

(71) Applicant: THALES, COURBEVOIE (FR)

(72) Inventors: Paul LALISSE-BAUVIN, RUNGIS (FR); Béatrice PESQUET-POPESCU, RUNGIS (FR); Andrei PURICA, RUNGIS (FR); David LAVILLE, RUNGIS (FR)

(21) Appl. No.: 18/008,436

(22) PCT Filed: Jun. 1, 2021
(86) PCT No.: PCT/EP2021/064635

§ 371 Date: Dec. 5, 2022

(30) Foreign Application Priority Data
Jun. 12, 2020 (FR) 2006172

(51) Int. Cl. G08G 5/06; G08G 5/00

(52) U.S. Cl. CPC G08G 5/065; G08G 5/0043

(57) ABSTRACT

A computer-implemented method is provided for training a supervised machine learning engine able to predict characteristics of aircraft trajectories from parameters of an aircraft, and environment parameters of the aircraft trajectory. A system able to train the supervised machine learning engine, a system for using the engine, and a computer-implemented method for using the engine are provided. The methods and systems provided are particularly useful for air traffic flow management applications.

### FIELD OF THE INVENTION

The present invention relates to the determination of aircraft trajectory parameters, for example taxiing times or flight times. The present invention also relates to the use of these aircraft trajectory parameters by operators, such as air traffic controllers, to regulate air traffic.

### PRIOR ART

Air traffic control systems aim to make the execution of flights safer, faster and more efficient. They make it possible to prevent collisions between aircraft, or hazardous situations between an aircraft and its environment (weather, terrain, etc.). They thus make it possible, by synchronizing the movement of aircraft as finely as possible, to ensure safe air traffic, but also allow aircraft to comply with scheduled flight times, and to adopt trajectories that are as fuel-saving as possible.

To this end, air traffic controllers receive a set of information relating to the airspace: predicted position and trajectories of aircraft, weather, etc. The controllers may also communicate, via written messages or oral communications, with aircraft pilots in order to retrieve additional information, where necessary, and give them instructions tailored to the situation, in order to guarantee air traffic safety, while at the same time ensuring the best possible quality of service for air transport users. For example, air traffic controllers may communicate to pilots the appropriate time to land at or take off from an airport, or by contrast instruct them to delay their approach if a landing runway is being used by aircraft at the initially scheduled time.

In a context of increasingly dense air traffic, the instructions provided to aircraft are based on predictions of the presence of aircraft at various locations. For example, air traffic controllers are able to predict in advance the taxiing duration for a given aircraft before take-off, take-off duration, cruising duration, etc. This makes it possible, for each aircraft, to evaluate the time for which it is present at a given location, and conversely the density of traffic at a location and at a given time. This allows air traffic controllers to provide aircraft with the appropriate instructions in order to ensure safety, but also to optimize air traffic. The ability of air traffic controllers to predict in advance the location of aircraft, and the duration of the various air traffic phases, is therefore essential in order to guarantee both the safety and the efficiency of air traffic, and to manage the flow of arrivals and departures of aircraft at airports.

Controllers nowadays rely on flow management tools that allow a controller to benefit from a prediction of aircraft trajectory parameters. These flow management tools are nowadays based on information stemming from a large number of parameters that are defined offline, which are tedious to introduce into the system, and/or stemming from analytical computations based on modeling that may prove approximate. Modern tools, in order to supply an effective prediction of aircraft flight parameters, would therefore require the manual introduction of prediction results corresponding to virtually all possible situations. Since this is not achievable in practice, modern tools supply inaccurate predictions, thus not allowing air traffic controllers to benefit from appropriate flow management support.

There is therefore a need for a method for predicting aircraft trajectory parameters that is able to supply reliable results for any air traffic flow management situation, while requiring a limited amount of training data.

### SUMMARY OF THE INVENTION

To this end, one subject of the invention is a computer-implemented method receiving, at input, a set of descriptions of aircraft trajectories, each associated with a set of input parameters, comprising, for each trajectory of an aircraft: at least one parameter of the aircraft; at least one environment parameter of the trajectory of the aircraft; said method comprising, for each trajectory: a step of forming a vector of input parameters comprising said input parameters; a step of extracting at least one parameter from the trajectory; said method comprising a step of training a supervised machine learning engine taking, at input, associations, for each trajectory respectively, between its vector of input parameters and at least one parameter of the trajectory.

Advantageously, the supervised machine learning engine is a fully connected neural network.

Advantageously, the at least one trajectory parameter is a taxi-out time, and the set of input parameters comprises at least one parameter chosen from a group comprising: a parking gate identifier; a take-off runway identifier, and/or line-up point identifier; meteorological information; a type of aircraft; an airline identifier; a ground traffic level; taxiway accessibility; a time of day.

Advantageously, the at least one trajectory parameter is a landing runway occupancy time, and the set of input parameters comprises at least one parameter chosen from a group comprising: a landing runway identifier; a parking gate identifier; meteorological information; a type of aircraft; an airline identifier; a type of approach.

Advantageously, the at least one trajectory parameter is a taxi-in time, and the set of input parameters comprises at least one parameter chosen from a group comprising: a landing runway identifier; a parking gate identifier; meteorological information; a type of aircraft; an airline identifier; a ground traffic level; an indication regarding closed taxiways; a time of day.

Advantageously, the at least one trajectory parameter is a landing runway occupancy time, and the set of input parameters comprises at least one parameter chosen from a group comprising: a landing runway identifier; a parking gate identifier; meteorological information; a type of aircraft; an airline identifier; a ground traffic level; an indication regarding closed taxiways; a time of day.

Advantageously, the at least one trajectory parameter is a description of an approach trajectory, and the set of input parameters comprises at least one parameter chosen from a group comprising: an aircraft speed; a type of aircraft; an altitude at what is called the meeting point; meteorological information; an airline identifier; an approach procedure and/or a type of approach; a time of day; an air traffic level; flight plan data; flight data originating from an air traffic control system.

Advantageously, the at least one trajectory parameter is an en-route flight time, and the set of input parameters comprises at least one parameter chosen from a group comprising: a type of aircraft, or a speed class of the aircraft; a flight altitude; meteorological information; an ATC sector description; a description of temporary segregated areas; an airline identifier; flight plan data; flight data originating from an air traffic control system.

Advantageously, the at least one trajectory parameter is a trajectory prediction for the aircraft over a time horizon, and the set of input parameters comprises at least one parameter chosen from a group comprising: a 3D position of the aircraft; a heading of the aircraft; information sent from the aircraft to air traffic control; flight plan data; flight data originating from an air traffic control system; a type of approach.

Advantageously, the at least one trajectory parameter is a possibility for the aircraft to overtake a second aircraft, and the set of input parameters comprises at least one parameter chosen from a group comprising: an identifier of an air corridor in which the aircraft are located; a type of the aircraft; a type of the second aircraft; an altitude of the aircraft; an altitude of the second aircraft; a speed of the aircraft; a speed of the second aircraft; a flight plan of the aircraft; a flight plan of the second aircraft.

Another subject of the invention is a system comprising: at least one computing unit able to train a supervised machine learning engine; access to at least one information storage medium storing, for each trajectory of an aircraft from among a set of aircraft trajectories: a description of the trajectory; a set of input parameters associated with the trajectory comprising: at least one parameter of the aircraft; at least one environment parameter of the trajectory of the aircraft; the at least one computing unit being configured, for each trajectory, to: form a vector of input parameters comprising the input parameters associated with the trajectory; extract at least one parameter from the trajectory; the at least one computing unit being configured to train a supervised machine learning engine taking, at input, associations, for each trajectory respectively, between its vector of input parameters and at least one parameter of the trajectory.

Another subject of the invention is a computer program comprising program code instructions for executing the steps of the method according to the invention when said program is executed on a computer.

Another subject of the invention is a computer-implemented method receiving, at input, for a trajectory of an aircraft, a set of input parameters comprising: at least one parameter of the aircraft; at least one environment parameter of the trajectory of the aircraft; said method comprising: a step of forming, for the trajectory, a vector of input parameters comprising said input parameters; a step of executing a supervised learning engine in order to compute, from the input vector, at least one parameter of the trajectory, said engine having been trained by a method according to the invention.

Another subject of the invention is a computer program comprising program code instructions for executing the steps of the method according to the invention when said program is executed on a computer.

Another subject of the invention is a system comprising: at least one computing unit able to execute a supervised machine learning engine; at least one computing unit able to execute a supervised machine learning engine; at least one input port able to receive, for a trajectory of an aircraft, a set of input parameters comprising: at least one parameter of the aircraft; at least one environment parameter of the trajectory of the aircraft; the at least one computing unit being configured to: form, for the trajectory, a vector of input parameters comprising said input parameters; execute said supervised learning engine in order to compute, from the input vector, at least one parameter of the trajectory, said engine having been trained by a method according to the invention.

Advantageously, the at least one computing unit is configured to use the at least one parameter of the trajectory as part of an air traffic flow management application.

Other features, details and advantages of the invention will become apparent upon reading the description given with reference to the appended drawings, which are given by way of example and in which, respectively:

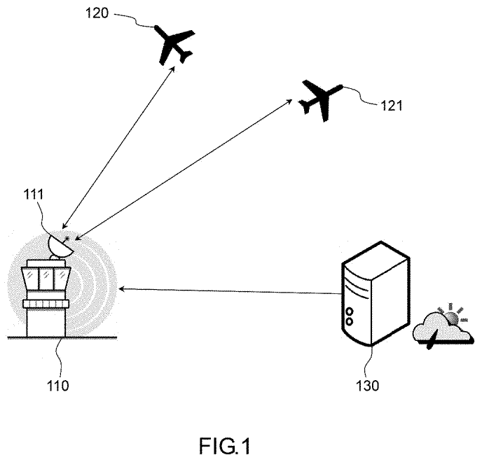

FIG. 1 shows an air traffic control system in which the invention may be implemented;

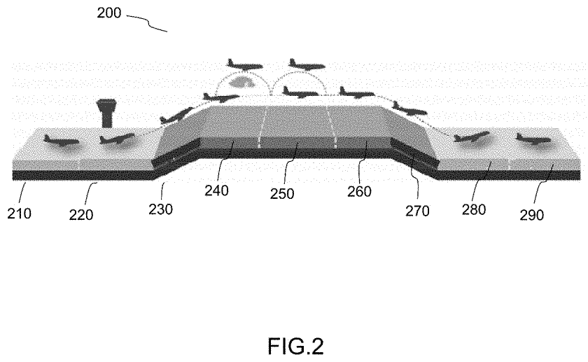

FIG. 2 shows a set of flight phases on which the invention is able to predict trajectory parameters;

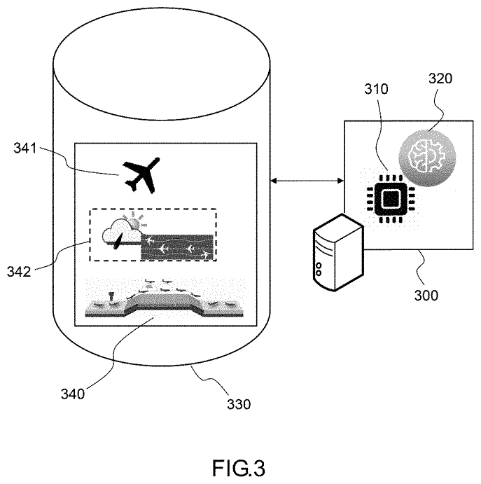

FIG. 3 shows a computing system for training a supervised machine learning engine for predicting at least one aircraft trajectory parameter, in one set of modes of implementation of the invention;

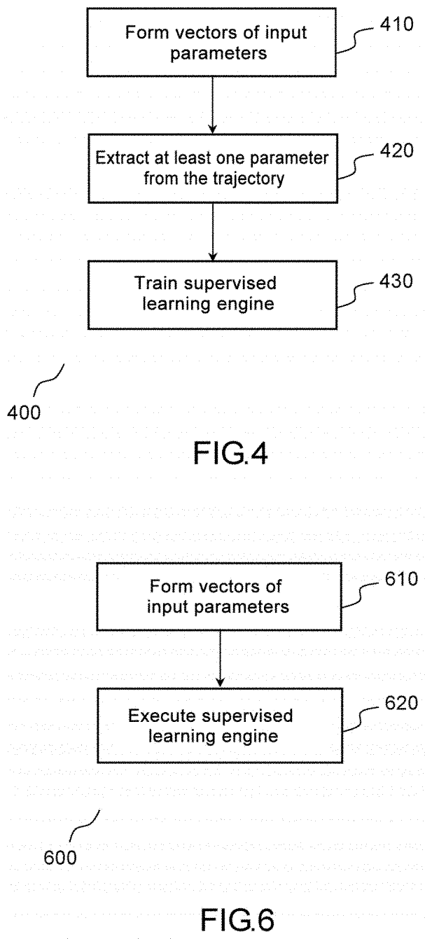

FIG. 4 shows a method for training a supervised machine learning engine for predicting at least one parameter of an aircraft trajectory, in one set of modes of implementation of the invention;

FIG. 5 shows a system for computing at least one aircraft trajectory parameter using a supervised machine learning engine, in one set of modes of implementation of the invention;

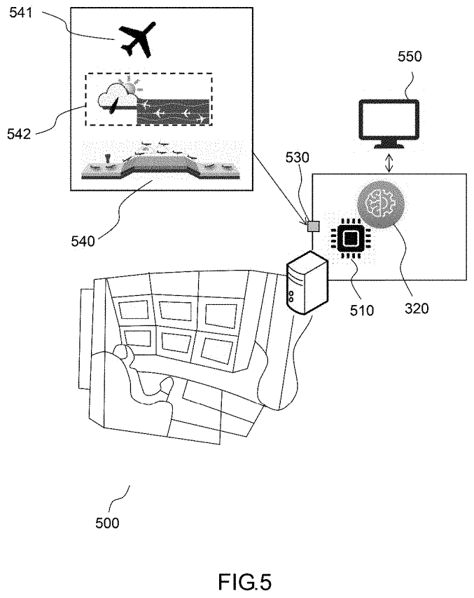

FIG. 6 shows a computer-implemented method for computing at least one parameter of an aircraft trajectory using a supervised machine learning engine, in one set of modes of implementation of the invention.

Some acronyms commonly used in the technical field of the present application may be used in the description. These acronyms are listed in the table below, notably with their English expression and their meaning.

| Acronym | Expression | Meaning |
|---|---|---|
| ACC | Area Control Center | Regional Control Center: Regional Center in |
| | | charge of air traffic safety. |
| AOC | Aeronautical | Aeronautical Operational Control. A set or |
| | Operational Control | subset of applications used by an aircraft to |
| | | communicate with ground services. |
| AMAN | Arrival MANager | Arrivals manager. Functionality of an air traffic |
| | | flow management application consisting in |
| | | managing aircraft arrivals (that is to say |
| | | allocating a landing slot, assigning a landing |
| | | runway, a gate, etc.). |
| ATC | Air Traffic Control | Air Traffic Control (ATC). Service provided by |
| | | air traffic controllers on the ground to safely |
| | | direct an aircraft to ground. |
| ATFM | Air Traffic Flow | Air Traffic Flow Management. Part of air traffic |
| | Management | management aimed at avoiding aerodrome |
| | | congestion. |
| ATM | Air Traffic Management | Air Traffic Management: all activities carried out |
| | | to ensure the safety and fluidity of air traffic. |
| CPDLC | Controller-Pilot | Controller-pilot communication data link. Method |
| | Data Link | for communication between controllers and |
| | Communications | pilots, defining a set of elementary messages |
| | | able to be exchanged. These messages |
| | | correspond to the procedures used for air traffic |
| | | control. |
| DMAN | Departure MANager | Departure manager. Functionality of an air |
| | | traffic flow management application consisting |
| | | in managing the departures of aircraft from an |
| | | airport, for example by allocating them a |
| | | departure time slot and a take-off runway. |
| FCN | Fully Connected Network | Fully Connected Network. Neural network in |
| | | which each layer is fully connected, that is to |
| | | say that each neuron in a layer has a |
| | | connection to all of the neurons in the previous |
| | | layer. |
| FIR | Flight Information Region | Flight Information Region: volume within which |
| | | a given control center ensures the smooth |
| | | running of flights. In France, FIRs cover a flight |
| | | space up to 19500 feet. |
| FL | Flight Level | Flight Level. In aeronautics, designates an |
| | | altitude expressed in hundreds of feet above the |
| | | isobaric surface 1013.25 hPa. |
| GPS | Global Positioning System | Global Positioning System. Satellite positioning |
| | | system. |
| GRIB | GRIdded Binary | File format used for broadcasting weather |
| | | forecast data. The GRIB format is standardized |
| | | by the World Meteorological Organization |
| | | (WMO). |
| ILS | Instrument Landing System | Instrument landing system. Type of approach |
| | | called precision approach, characterized by the |
| | | use of precise radio navigation for the approach |
| | | of an aircraft. |
| NAS | Network Accessed | Network Storage Server. Autonomous file server, |
| | Server | connected to a network and the data of which are |
| | | accessed remotely. |
| ROT | Runway Occupancy Time | Occupancy time of an aircraft on a landing or |
| | | take-off runway. |
| SIGMET | SIGnificant | Significant Meteorological Information. Type of |
| | METeorological | message intended for aircraft in flight reporting |
| | Information | observed or forecast highly dangerous |
| | | meteorological phenomena. |
| UIR | Upper Information | Upper Information Region: Flight Information |
| | Region | Region covering, in France, the airspace located |
| | | above 19500 feet. |
| VCS | Voice Communication | Voice Communication Systems. Voice |
| | Systems | communication systems used in air traffic. |
| XMAN | X MANager | “X” manager. Functionality of an air traffic flow |
| | | management application consisting of a |
| | | combination of a departure manager (DMAN) |
| | | and arrival manager (AMAN). |

FIG. 1 shows one example of an air traffic control system in which the invention may be implemented.

The air traffic control system shown in FIG. 1 comprises a control tower 110, equipped with a radar 111 for locating aircraft 120, 121 flying in a given sector. The control tower 110 is able to communicate with the aircraft, for example via a radio link, in order to give information and instructions to the aircraft, but also to receive information and requests from the aircraft. In order to provide the aircraft with the most relevant indications, the control tower is able to receive data from external providers, such as a weather server 130. An air traffic controller is thus able to provide indications and instructions to the pilots of aircraft from a set of data comprising the scheduled trajectories of the aircraft on his sector, interactions with the pilots, and environmental data such as weather forecasts.

The system of FIG. 1 is given solely by way of non-limiting example, and the invention may be implemented in numerous air traffic control systems, such as ATC or ATFM systems.

FIG. 2 shows a set of flight phases on which the invention is able to predict trajectory parameters.

The invention may be applied to numerous flight phases.

FIG. 2 shows one example of an aircraft trajectory 200, comprising the following phases:
a taxiing phase at the departure airport 210;
a take-off phase 220;
a climbing (departure) phase 230;
a cruising phase, itself consisting of route phases 240, 260, and an ocean overflight phase 250;
a descent phase 270;
a landing phase 280;
a taxiing phase at the arrival airport 290.

Each of these phases may be associated, in the flight plan of the aircraft, with a nominal duration. However, each of them may also be subject to delays, for reasons that may be related to the aircraft or to its environment. For example, the taxiing phase 210 may be extended if the take-off runway is congested and does not allow take-off at the initially scheduled time. These various delays may also have repercussions on the subsequent phases of the trajectory. The trajectory shown in FIG. 2 is provided solely by way of example, and the invention could be applied to numerous other trajectories, characterized by different flight phases.

This uncertainty reduces the ability of air traffic controllers to perform effective flow management. The invention makes it possible to predict, from a set of parameters related to the aircraft and/or to its environment, parameters of the trajectory of the aircraft, and notably the duration of the various phases of a trajectory, in flight or on the ground.

FIG. 3 shows a computing system for training a supervised machine learning engine for predicting at least one aircraft trajectory parameter, in one set of modes of implementation of the invention.

The system 300 is a computing system. According to one set of embodiments of the invention, the system 300 may be a single computing device such as a computer, a server, or any other system able to perform computing operations. The system 300 may also comprise a plurality of computing devices. For example, the system 300 may be a server farm comprising multiple computing servers.

The system 300 thus comprises at least one computing unit 310 able to train a supervised machine learning engine 320.

The at least one computing unit 310 may be any type of computing unit able to perform computing operations. For example, the computing unit may be a processor configured with machine instructions, a microprocessor, an integrated circuit, a microcontroller, a programmable logic circuit, or any other computing unit able to be programmed to perform computing operations.

The supervised machine learning engine 320 may be any type of supervised machine learning engine. For example, it may be a random forest, an artificial neural network, a support vector machine, or a deep learning engine, such as a deep neural network, a fully connected neural network (FCN), or a convolutional neural network. Although any type of supervised learning engine may be used in the invention, a supervised learning engine based on a neural network is particularly advantageous, since it is able, once learning has been carried out, to be executed in a limited time. Executing an artificial neural network, once it has been trained, also requires a limited amount of computing resources.

A fully connected neural network (FCN) is particularly advantageous, since it allows learning using inferences between all parameters, and is therefore highly effective in terms of predicting interactions between highly different parameters.

The system 300 comprises access to at least one information storage medium 330. The at least one information storage medium 330 may be of any type of storage able to store information: hard drive, CD, DVD, magnetic tape, a memory card, a USB key, a Flash memory, a random access memory.

The information storage medium may be integrated into the system 300. For example, if the system 300 is a computing device such as a server, the information storage medium may be a hard drive of the device. If the system 300 consists of a plurality of computing devices, the at least one storage medium may be a set of memories distributed over the various computing devices.

The system 300 may also have access to the at least one information storage medium 330 via a connection. For example, the at least one information storage medium may consist of at least one hard drive that is accessed remotely, for example via at least one NAS server, or via a cloud computing system.

The at least one information storage medium 330 stores a set of aircraft trajectory descriptions 340, and, for each aircraft trajectory, a set of associated input parameters comprising:
parameters of the aircraft 341;
environment parameters 342 of the trajectory of the aircraft.

The aircraft trajectories 340 may be described in various ways. For example, the trajectories may be expressed in the form of 4D trajectories, with waypoints defined by a latitude, longitude, and an FL and a crossing time. The trajectories may also comprise, for each waypoint, an associated heading. A trajectory may also be associated with a type of aircraft and/or a call sign (name of a given aircraft). The trajectories may comprise not only portions en route, but also portions on the ground, comprising notably the trajectory and taxiing times of the aircraft.

The parameters of the aircraft 341 may comprise various parameters such as the type of aircraft or the airline to which the aircraft belongs. These parameters may also comprise parameters related to the past trajectory or to the flight plan of the aircraft, such as:
aircraft flight plan parameters;
a type of approach;
a scheduled departure or arrival time;
the heading of the aircraft;
flight altitude;
the position of the aircraft;
a type of approach used by the aircraft.

More generally, these parameters may comprise any type of parameter related to the aircraft itself or to its scheduled trajectory.

The environment parameters 342 may comprise numerous types of parameters related to the environment of the trajectory of the aircraft. These parameters may for example comprise parameters relating to air traffic, to the departure airport, to the arrival airport, to the weather conditions, to a sector passed through by the aircraft. According to various embodiments of the invention, the environment parameters 342 may for example comprise:
an aircraft parking identifier;
an aircraft take-off or landing runway;
measured or predicted meteorological data: wind, humidity, rain, snow, visibility, etc.;
ground traffic;
the availability of taxiways at a departure or arrival airport;
the taxiway assigned to the aircraft;
the time;
in-flight traffic.
   More generally, any parameter relating to the environment of the aircraft may be used according to various embodiments of the invention. The concept of an environment of the aircraft may refer both to the physical environment, with meteorological parameters, and to parameters related to movement and to air traffic. The present description will describe a few particularly relevant parameter associations in more detail.

The parameters may be expressed in any suitable way depending on the parameter under consideration.

For example, meteorological parameters may notably comprise at least one of the following types of information: numerical information (temperatures, winds, pressures, etc.), for example by way of a GRIB file, descriptive text of the weather (for example, presence of a storm, thunderstorm, etc.), SIGMET messages. More generally, any type of data providing indications about the weather within the sector may be used.

Parameters related to air traffic, or to taxiing traffic, may be expressed for example in the form of an aircraft density. This density may be expressed in various ways, such as a number of aircraft in a given sector, or a number of aircraft within a given volume.

These parameters correspond to records of real situations that have occurred for the trajectories under consideration. They thus define, for each trajectory, the input parameters having an influence on the trajectory, and making it possible to predict certain features thereof. As indicated above, these parameters comprise at least one parameter of the aircraft, of its past trajectory or of its flight plan, and at least one parameter of the environment of the aircraft.

More generally, the parameters may comprise, according to various embodiments of the invention, any type of parameter that may have an impact on the taxiing or flight trajectory of the aircraft.

The aircraft trajectories 340, aircraft parameters 341 and environment parameters 342 that are stored may originate from various sources: sensor measurements, data collected by air traffic control services, by weather services, flight data. In general, a large amount of data is collected and stored for each aircraft flight, originating for example from sensors of the aircraft and from air traffic control. One of the objectives of the invention is to utilize these data by using them as training data in order to have predictors of trajectory parameters that are more reliable than the predictors from the prior art.

The at least one computing unit 310 is configured to train the machine learning engine to compute, for a given trajectory, at least one parameter of the trajectory, from the corresponding input parameters. The learning method implemented by the at least one computing unit 310 is described in more detail with reference to FIG. 4 below.

FIG. 4 shows a method for training a supervised machine learning engine for predicting at least one parameter of an aircraft trajectory, in one set of modes of implementation of the invention.

The method 400 takes, at input, a set of descriptions of aircraft trajectories such as the trajectories 340, and also, for each trajectory, a set of input parameters comprising at least one parameter of the aircraft 341, and at least one environment parameter 342 of the trajectory of the aircraft. These parameters may for example correspond to the parameters discussed with reference to FIG. 3, and other specific examples of parameters according to various embodiments of the invention will be provided below.

The method 400 comprises a subset of steps intended to associate, with each trajectory, a vector of input parameters and at least one parameter of the trajectory. The steps of the method 400 may be executed on all or some of the trajectories.

The method 400 comprises a step 410 of forming a vector of input parameters comprising the input parameters associated with a given trajectory. This step makes it possible, for each trajectory, to formalize the relevant input parameters in the form of a vector able to be used at input of a machine learning engine.

The method comprises a step 420 of extracting at least one parameter from the trajectory. This step consists in extracting, from a given trajectory, the parameters for which a prediction is desired. These parameters may for example comprise one or more parameters chosen from among:
a taxi-out time;
a taxi-in time;
a flight time;
an en-route flight time;
an approach trajectory;
a runway occupancy time (ROT);
the performance of a holding procedure (holding pattern) before landing;
the use of a missed approach/go-around procedure;
a most probable trajectory followed by an aircraft;
a possibility of overtaking an aircraft.

In general, numerous trajectory parameters may be predicted. The invention is more particularly suited to predicting trajectory parameters having an impact on the management of air traffic flows by air traffic controllers. For example, each of the trajectory parameters above impacts air traffic flow management, for example by impacting the periods of availability of the runways of an airport, or the ability of aircraft to overtake other slower aircraft.

Each of the parameters may be extracted in different ways depending on the parameter that is extracted. For example, some parameters (go-around, possibility of overtaking an aircraft, etc.) may be recorded as events in the trajectory. They may also be deduced from recorded data, such as the messages exchanged between the aircraft and the ATC service. Yet others may be computed, such as taxi-out times, by computing the difference between the take-off time and the hangar exit time. Those skilled in the art will be able to easily define the most appropriate way to extract a given parameter, depending on all of the data available. In general, all of these data are stored in the ATM system and are easily accessible.

Each of the parameters may be obtained in the most suitable form. For example, the (flight, cruising flight, taxiing, etc.) times may be obtained in the form of a duration, expressed for example in minutes, seconds, etc.; some parameters, such as the use of a go-around procedure, the performance of a holding procedure or the performance of an overtake, may be obtained in binary form, indicating whether or not the event has taken place. Those skilled in the art will be able to easily identify the most relevant form for each of the parameters.

Steps 410 and 420 are repeated for each trajectory.

When a vector of input parameters and at least one parameter of the trajectory have been obtained for the desired trajectories, the method 400 comprises a step 430 of training a supervised machine learning engine such as the engine 320, said engine taking, at input, the associations, for each trajectory respectively, between the vector of input parameters and the at least one parameter of the trajectory corresponding to each trajectory.

Thus, for each trajectory, the vector of input parameters serves as a feature vector, and the at least one parameter of the label trajectory. The machine learning engine 320 may thus be trained to predict the at least one parameter, for each trajectory, from the vector of input parameters.

Once it has been trained, the machine learning engine 320 is capable of predicting, for a new trajectory, the at least one parameter thereof based on the associated vector of input parameters. Such an engine has the advantage of requiring limited resources to predict the at least one parameter of a given trajectory. Machine learning engines are thus able to predict the desired parameters of the trajectories in a limited time. This therefore makes it possible to ensure that it is possible to determine the desired parameters of the trajectories practically in real time, thus allowing the parameters to be used in a real-time air traffic flow management application.

Once the learning engine 320 has been trained, it is capable of computing the at least one parameter of a new trajectory, from a vector of data of the same type as those with which it was trained, comprising notably at least one parameter of the aircraft, and at least one environment parameter of the trajectory of the aircraft.

This makes it possible to predict the desired parameters for new aircraft and new trajectories, thereby allowing a reliable prediction of the one or more parameters of the trajectory. This allows them notably to be used in air traffic flow management applications.

In FIG. 4, the steps of the method 400 are presented in the following order: steps 410, 420 and then 430. However, this order is given by way of indication and, according to some embodiments of the invention, some steps may be performed in different orders. For example, it is possible to perform steps 410 and 420 in the reverse order to that indicated, or to perform them in parallel.

A few specific exemplary applications of the invention will now be described.

### Example 1—Training an Engine to Compute Trajectory Parameters Related to a Departure Manager (DMAN)

In one set of embodiments of the invention, the engine 320 may be trained to compute parameters able to be used in a DMAN module. One of the main objectives of a DMAN module is to construct an aircraft pre-departure sequence, that is to say to determine the order in which aircraft will leave an airport. One essential parameter for achieving this is what is called the “taxi-out” time of an aircraft, that is to say the time for which the aircraft will have to taxi in the airport between exiting the hangar and take-off. In practice, this time depends on a number of highly different factors. For example, the weather has an impact on this time: an aircraft pilot will taxi more slowly in the event of fog or snow than in the event of clear weather; ground traffic density will also have an impact; the model of the aircraft may also have an impact, since aircraft do not have the same performance; the airline may also come into play, as pilots from various airlines may have different practices and training.

The solutions from the prior art do not allow a reliable prediction of the taxi-out time. By contrast, the invention makes it possible to train the engine 320 to predict the taxi-out time by taking, as input parameters, at least one parameter chosen from among:
a parking gate identifier;
a take-off runway identifier, and/or line-up point identifier;
meteorological information;
a type of aircraft;
an airline identifier;
a ground traffic level;
taxiway accessibility;
a time of day.

The engine 320 is thus capable, by comparing, within historical situations, the values of these input parameters with the taxi-out times that are actually observed, of training itself to supply a reliable prediction of taxi-out time, taking into account not only the input parameters taken individually, but also the interactions between them.

Of course, the application of the invention to computing a taxi-out time is not limited to this list of parameters: according to various embodiments of the invention, only some of them are used. By contrast, other parameters may be used in addition. The choice of parameters may depend on the parameters influencing the taxi-out time, but also on the availability of measurements for the various parameters.

If meteorological information is used, information having an impact on visibility (snow, rain, fog, etc.) is particularly relevant.

According to various embodiments, the engine 320 may be trained either generically with data originating from multiple airports or specifically for a given airport.

Training the engine 320 to efficiently compute the taxi-out time makes it possible to considerably improve air traffic flow management within an AMAN module.

### Example 2—Training an Engine to Compute Trajectory Parameters Related to an Arrival Manager (AMAN)

In one set of embodiments of the invention, the engine 320 may be trained to compute parameters able to be used in an AMAN module. One of the main objectives of an AMAN module is to optimize the choice of arrival runways and gates allocated to aircraft arriving at an airport, and also to indicate arrival times at nearby airports.

A first essential parameter to achieve this is the ROT (Occupancy time of an aircraft on a landing runway).

The solutions from the prior art do not allow a reliable prediction of the ROT. By contrast, the invention makes it possible to train the engine 320 to predict the ROT by taking, as input parameters, at least one parameter chosen from among:
a landing runway identifier;
a parking gate identifier;
meteorological information;
a type of aircraft;
an airline identifier;
a type of approach (which may for example be chosen from a visual approach, an ILS approach, etc.).

Indeed, the engine 320 is capable, by comparing, within historical situations, the values of these input parameters with the ROTs that are actually observed, of training itself to supply a reliable prediction of the ROTs, taking into account not only the input parameters taken individually, but also the interactions between them.

A second essential parameter for optimizing the operation of an AMAN is the taxi-in time.

The solutions from the prior art do not allow a reliable prediction of the taxi-in time. By contrast, the invention makes it possible to train the engine 320 to predict the taxi-in time by taking, as input parameters, at least one parameter chosen from among:
a landing runway identifier;
a parking gate identifier;
a type of aircraft;
an airline identifier;
a time of day;
a ground traffic level;
meteorological information;
an indication regarding closed taxiways.

Indeed, the engine 320 is capable, by comparing, within historical situations, the values of these input parameters with the taxi-in times that are actually observed, of training itself to supply a reliable prediction of taxi-in times, taking into account not only the input parameters taken individually, but also the interactions between them.

Of course, the application of the invention to computing a taxi-in time and ROT is not limited to these lists of parameters: according to various embodiments of the invention, only some of them are used. By contrast, other parameters may be used in addition. The choice of parameters may depend on the parameters influencing the taxi-in time and/or the ROT, but also on the availability of measurements for the various parameters.

If meteorological information is used, information having an impact on visibility (snow, rain, fog, etc.) is particularly relevant.

According to various embodiments, the engine 320 may be trained either generically with data originating from multiple airports or specifically for a given airport.

Training the engine 320 to efficiently compute the taxi-in time and/or the ROT makes it possible to considerably improve air traffic flow management within an AMAN module.

### Example 3—Training an Engine to Compute Approach Trajectories

In one set of embodiments of the invention, the engine 320 may be trained to compute approach trajectories, which are used notably in AMAN modules. Indeed, an effective prediction of approach trajectories makes it possible to calibrate the arrival of aircraft at an airport. However, the approach trajectories that are actually applied are dependent on a large number of factors. For example, the weather has an impact on these trajectories: an aircraft pilot will not use the same trajectory depending on the weather, be this because of different visibility, or differences in the behavior of the aircraft; the model of the aircraft may also have an impact, since aircraft do not have the same performance; the airline may also come into play, as pilots from various airlines may have different practices and training.

The solutions from the prior art do not allow a reliable prediction of the approach trajectories. By contrast, the invention makes it possible to train the engine 320 to predict an approach trajectory by taking, as input parameters, at least one parameter chosen from among:
an aircraft speed;
a type of aircraft;
an altitude at what is called the meeting point (point on which the airport area entrance trajectories converge-feeder-fix);
meteorological information;
an airline identifier;
an approach procedure and/or a type of approach;
a time of day; van air traffic level;
flight plan data;
flight data originating from an air traffic control system.

Indeed, the engine 320 is thus capable, by comparing, within historical situations, the values of these input parameters with the approach trajectories that are actually observed, of training itself to supply a reliable prediction of an approach trajectory, taking into account not only the input parameters taken individually, but also the interactions between them.

The approach trajectory may be represented in various ways. It may for example be represented in the form of an approach time. This may for example be represented as an approach duration, or an approach time probability distribution. The approach trajectory may also be represented in the form of a 4D trajectory, that is to say a sequence of 3D points associated with crossing times, which may be supplied to an avionics computing engine in order to construct an avionics trajectory therefrom.

The approach trajectory may also comprise an indication of specific approach situations, such as an indication that the aircraft is performing an approach procedure (holding pattern), a missed approach/go-around procedure, or another particular situation (temporary exclusion area, closed landing runway, etc.). The learning engine 320 will thus be capable of efficiently predicting the occurrence of particular situations, thereby also allowing it to better predict the approach trajectory, regardless of the form that is used (approach time, 3D trajectory, etc.).

Of course, the application of the invention to determining approach trajectories is not limited to this list of parameters: according to various embodiments of the invention, only some of them are used. By contrast, other parameters may be used in addition. The choice of parameters may depend on the parameters influencing the approach trajectory, but also on the availability of measurements for the various parameters.

According to various embodiments, the engine 320 may be trained either generically with data originating from multiple airports or specifically for a given airport.

Training the engine 320 to efficiently compute approach trajectories makes it possible to considerably improve air traffic flow management within an AMAN module.

### Example 4—Training an Engine to Compute En-Route Flight Time

In one set of embodiments of the invention, the engine 320 may be trained to compute en-route flight times, which are used notably in AMAN modules. Indeed, an effective prediction of the times spent by aircraft en-route for various trajectories makes it possible to better ascertain their arrival time at an airport. However, en-route flight times are dependent on a large number of factors.

The solutions from the prior art do not allow a reliable prediction of en-route flight times. By contrast, the invention makes it possible to train the engine 320 to predict en-route flight times by taking, as input parameters, at least one parameter chosen from among:
a type of aircraft, or a speed class of the aircraft;
a flight altitude;
meteorological information;
an ATC sector description;
a description of temporary segregated areas;
an airline identifier;
flight plan data;
flight data originating from an air traffic control system.

Indeed, the engine 320 is capable, by comparing, within historical situations, the values of these input parameters with the en-route flight times that are actually observed, of training itself to supply a reliable prediction of en-route flight times, taking into account not only the input parameters taken individually, but also the interactions between them.

In embodiments in which weather information is used, weather information having an impact on the ability of an aircraft to fly over an area, or affecting the speed and/or the way in which the area is flown over (wind, storms, thunderstorms, etc.) is particularly relevant.

Of course, the application of the invention to determining en-route flight times is not limited to this list of parameters: according to various embodiments of the invention, only some of them are used. By contrast, other parameters may be used in addition. The choice of parameters may depend on the parameters influencing the en-route flight time, but also on the availability of measurements for the various parameters.

Training the engine 320 to efficiently compute en-route flight times makes it possible to considerably improve air traffic flow management within an AMAN module, by allowing better knowledge of the arrival times of aircraft.

### Example 5—Prediction of a Most Probable Trajectory

In one set of embodiments of the invention, the engine 320 may be trained to compute a most probable trajectory of an aircraft. Indeed, aircraft do not always follow their flight plans exactly, but it is highly difficult to determine a priori what their exact trajectory will be. This prediction makes it possible notably to adapt to real aircraft traffic flows.

The solutions from the prior art do not allow a reliable prediction of the most probable trajectories. By contrast, the invention makes it possible to train the engine 320 to predict most probable trajectories by taking, as input parameters, at least one parameter chosen from among:
a 3D position of the aircraft;
a heading of the aircraft;
information sent from the aircraft to air traffic control;
flight plan data;
flight data originating from an air traffic control system;
a type of approach.

The most probable trajectory may be represented in various forms, for example a sequence of 4D positions (3D positions associated with a crossing time). In general, the most probable trajectory will consist of a trajectory prediction over a defined time horizon, corresponding to the continuation of the trajectory of the aircraft over a given duration.

The engine 320 is thus capable, by comparing, within historical situations, the values of these input parameters with the 3D trajectories that are actually followed, of training itself to supply a reliable prediction of the trajectory of the aircraft, taking into account not only the input parameters taken individually, but also the interactions between them. The engine that is thus trained will therefore be capable of predicting, in a given situation, the trajectory actually followed by the aircraft to a given time horizon, much more accurately than the methods from the prior art.

Of course, the application of the invention to trajectory prediction over a time horizon is not limited to this list of parameters: according to various embodiments of the invention, only some of them are used. By contrast, other parameters may be used in addition. The choice of parameters may depend on the parameters influencing the trajectory actually followed, but also on the availability of measurements for the various parameters.

Training the engine 320 to efficiently compute a trajectory over a time horizon makes it possible to considerably improve air traffic flow management both within an AMAN module and within a DMAN module, by allowing better knowledge of the trajectories actually followed by aircraft.

### Example 6—Prediction of a Possibility of Overtaking

In one set of embodiments of the invention, the engine 320 may be trained to compute a possibility of overtaking, that is to say the ability of an aircraft to overtake an aircraft located in front of it and flying at a lower speed. The possibility of overtaking modifies the time at which an aircraft arrives at an airport, but is dependent on a large number of factors, such as the air corridor being followed, or the respective speeds of the aircraft. This prediction makes it possible notably to adapt to real aircraft traffic flows.

The solutions from the prior art do not allow a reliable prediction of possibilities of overtaking. By contrast, the invention makes it possible to train the engine 320 to predict the ability of an aircraft to overtake a second aircraft by taking, as input parameters, at least one parameter chosen from among:
an identifier of an air corridor in which the aircraft are located;
a type of the aircraft;
a type of the second aircraft;
an altitude of the aircraft;
an altitude of the second aircraft;
a speed of the aircraft;
a speed of the second aircraft;
a flight plan of the aircraft;
a flight plan of the second aircraft.

The possibility of overtaking may be represented in various ways, for example in the form of a binary value (overtaking authorized or not).

The engine 320 is thus capable, by comparing, within historical situations, the values of these input parameters with an actual validation of the possibility of overtaking the second aircraft, of training itself to supply a reliable prediction of the possibility of overtaking a second aircraft, taking into account not only the input parameters taken individually, but also the interactions between them. The engine that is thus trained will therefore be capable of predicting, in a given situation, whether an aircraft is capable of overtaking a second aircraft, much more accurately than the methods from the prior art.

Of course, the application of the invention to predicting a possibility of overtaking is not limited to this list of parameters: according to various embodiments of the invention, only some of them are used. By contrast, other parameters may be used in addition. The choice of parameters may depend on the parameters influencing the possibility of overtaking, but also on the availability of measurements for the various parameters.

Training the engine 320 to efficiently compute an ability to overtake makes it possible to considerably improve air traffic flow management, notably within an AMAN module, by allowing better knowledge of the arrival times of aircraft.

FIG. 5 shows a system for computing at least one aircraft trajectory parameter using a supervised machine learning engine, in one set of modes of implementation of the invention.

The system 500 may be for example an ATM, ATC or ATFM system, using an air traffic flow management application, allowing air traffic controllers to manage the flow of aircraft in a given area, for example within AMAN, DMAN or XMAN applications.

The system 500 is a computing system. According to one set of embodiments of the invention, the system 500 may be a single computing device such as a computer, a server, or any other system able to perform computing operations. The system 500 may also comprise a plurality of computing devices. For example, the system 500 may be a server farm comprising multiple computing servers.

The system 500 thus comprises at least one computing unit 510 able to execute a supervised machine learning engine 320, similar to the supervised learning engine shown in FIG. 3. According to one set of embodiments of the invention, the supervised machine learning engine 320 has been trained by a method such as the method 400, and/or a system such as the system 300.

The at least one computing unit 510 may be any type of computing unit able to perform computing operations. For example, the computing unit may be a processor configured with machine instructions, a microprocessor, an integrated circuit, a microcontroller, a programmable logic circuit, or any other computing unit able to be programmed to perform computing operations.

The system 500 comprises at least one input port 530 able to receive input parameters for a trajectory of an aircraft. The input parameters 541, 542 are of the same type as the input parameters 341, 342. The system 500 is therefore able to receive:
at least one parameter 541 of the aircraft;
at least one environment parameter 542 of the aircraft trajectory.

According to various embodiments, other types of input parameters may be received. In particular, all of the embodiments outlined in FIGS. 3 and 4 may be applied to the system 500.

The input parameters may be received in various ways. For example, the flight plans and instantaneous parameters of aircraft or of their trajectories may be received through radio communication with the aircraft, by way of radar measurements, etc. The aircraft environment information may be received for example by way of measurements (radar, weather radar, etc.), through subscription to an external service (weather service, etc.), or through ATC services.

For this purpose, the at least one port 530 may be of various types: Internet connection, radio link, etc. The invention is not limited to one type of input port, and those skilled in the art will be able to adapt the reception of the input parameters to the input channels that are available. Likewise, according to various modes of implementation of the invention, the various input parameters may be received on a single port, or multiple ports, of the same type or of different types. For example, the at least one parameter of the aircraft 541 may be received through radio link, and the at least one environment parameter of the trajectory of the aircraft 542 through an Internet connection.

The at least one computing unit 510 is configured to form, for the trajectory, a vector of input parameters comprising said input parameters.

The at least one computing unit 510 is also configured to compute, from the input vector, at least one parameter of the trajectory. Numerous trajectory parameters may be computed. In particular, all of the embodiments discussed with reference to FIGS. 3 and 4 may be used here.

The system 500 is thus capable of computing at least one parameter of the trajectory of the aircraft, while benefiting from the advantages of training the supervised learning engine.

In particular, the supervised learning engine 320 makes it possible to compute the parameters of the trajectory with limited resource requirements, and a deterministic execution time. This makes it possible to use the parameters reactively, for example within an air traffic flow management application, in which it is important to be able to evaluate the impact of aircraft on each other, in real time.

Once the at least one trajectory parameter has been computed, the system 500 may use it in various ways. For example, it may display it to at least one operator, for example an air traffic controller, by way of at least one screen 550. This allows the operator to use this parameter for his interaction with aircraft. He may also raise an alert if the value of the parameter indicates a difficulty in the air traffic flow management.

In one set of embodiments of the invention, the at least one computing unit 510 is configured to use the at least one computed parameter of the trajectory as part of an air traffic flow management application.

This may for example be achieved by using a taxiing time computed by the supervised machine learning engine 320 to determine the time at which a take-off runway will be available for a new aircraft, by using the computation of an overtaking ability to have a more reliable prediction of the position of an aircraft in the future, etc. The invention thus makes it possible to have reliable and fast computation of aircraft trajectory parameters, thus allowing flow management that is both reliable and reactive.

Although FIG. 5 shows a single supervised learning engine 320, according to various embodiments of the invention, multiple different engines may be used. For example, a first engine may be used to compute trajectory parameters for a “DMAN” application (taxi-out time, take-off time, etc.), and a second engine to compute trajectory parameters for an “AMAN” application (arrival time, usage time of a runway for landing, taxiing time on arrival, etc.). This makes it possible to simultaneously optimize various modules of an air traffic flow management system, and thus have a joint improvement in flow management.

FIG. 6 shows a computer-implemented method for computing at least one parameter of an aircraft trajectory using a supervised machine learning engine, in one set of modes of implementation of the invention.

The method 600 receives, at input, for an aircraft trajectory, a set of input parameters comprising:
at least one parameter 541 of the aircraft;
at least one environment parameter 542 of the trajectory of the aircraft.

The method comprises a step 610 of forming, for the trajectory, a vector of input parameters comprising said input parameters.

The method then comprises a step 620 of executing a supervised learning engine 320 in order to compute, from the input vector, at least one parameter of the trajectory, said engine having been trained by the method 400.

All of the embodiments discussed with reference to FIGS. 3 to 5 are respectively applicable to the method 600.

The above examples demonstrate the ability of the invention to compute aircraft trajectory parameters, and to use these parameters in air traffic flow management applications. However, they are only given by way of example and in no way limit the scope of the invention as defined in the claims below.

1. A computer-implemented method receiving, at input, a set of descriptions of aircraft trajectories, each associated with a set of input parameters, comprising, for each trajectory of an aircraft:
at least one parameter of the aircraft;
at least one environment parameter of the trajectory of the aircraft;
said method comprising, for each trajectory:
a step of forming a vector of input parameters comprising said input parameters;
a step of extracting at least one parameter from the trajectory;
said method comprising a step of training a supervised machine learning engine taking, at input, associations, for each trajectory respectively, between its vector of input parameters and at least one parameter of the trajectory.

2. The method as claimed in claim 1, wherein the supervised machine learning engine is a fully connected neural network (FCN).

3. The method as claimed in claim 1, wherein the at least one trajectory parameter is a taxi-out time, and the set of input parameters comprises at least one parameter chosen from a group comprising:
a parking gate identifier;
a take-off runway identifier, and/or line-up point identifier;
meteorological information;
a type of aircraft;
an airline identifier;
a ground traffic level;
taxiway accessibility;
a time of day.

4. The method as claimed in claim 1, wherein the at least one trajectory parameter is a landing runway occupancy time, and the set of input parameters comprises at least one parameter chosen from a group comprising:
a landing runway identifier;
a parking gate identifier;
meteorological information;
a type of aircraft;
an airline identifier;
a type of approach.

5. The method as claimed in claim 1, wherein the at least one trajectory parameter is a taxi-in time, and the set of input parameters comprises at least one parameter chosen from a group comprising:
a landing runway identifier;
a parking gate identifier;
meteorological information;
a type of aircraft;
an airline identifier;
a ground traffic level;
an indication regarding closed taxiways;
a time of day.

6. The method as claimed in claim 1, wherein the at least one trajectory parameter is a landing runway occupancy time, and the set of input parameters comprises at least one parameter chosen from a group comprising:
a landing runway identifier;
a parking gate identifier;
meteorological information;
a type of aircraft;
an airline identifier;
a ground traffic level;
an indication regarding closed taxiways;
a time of day.

7. The method as claimed in claim 1, wherein the at least one trajectory parameter is a description of an approach trajectory, and the set of input parameters comprises at least one parameter chosen from a group comprising:
an aircraft speed;
a type of aircraft;
an altitude at what is called the meeting point;
meteorological information;
an airline identifier;
an approach procedure and/or a type of approach;
a time of day;
an air traffic level;
flight plan data;
flight data originating from an air traffic control system.

8. The method as claimed in claim 1, wherein the at least one trajectory parameter is an en-route flight time, and the set of input parameters comprises at least one parameter chosen from a group comprising:
a type of aircraft, or a speed class of the aircraft;
a flight altitude;
meteorological information;
an ATC sector description;
a description of temporary segregated areas;
an airline identifier;
flight plan data;
flight data originating from an air traffic control system.

9. The method as claimed in claim 1, wherein the at least one trajectory parameter is a trajectory prediction for the aircraft over a time horizon, and the set of input parameters comprises at least one parameter chosen from a group comprising:
a 3D position of the aircraft;
a heading of the aircraft;
information sent from the aircraft to air traffic control;
flight plan data;
flight data originating from an air traffic control system;
a type of approach.

10. The method as claimed in claim 1, wherein the at least one trajectory parameter is a possibility for the aircraft to overtake a second aircraft, and the set of input parameters comprises at least one parameter chosen from a group comprising:
an identifier of an air corridor in which the aircraft are located;
a type of the aircraft;
a type of the second aircraft;
an altitude of the aircraft;
an altitude of the second aircraft;
a speed of the aircraft;
a speed of the second aircraft;
a flight plan of the aircraft;
a flight plan of the second aircraft.

11. A system comprising:
at least one computing unit able to train a supervised machine learning engine;
access to at least one information storage medium storing, for each trajectory of an aircraft from among a set of aircraft trajectories:
a description of the trajectory;
a set of input parameters associated with the trajectory comprising:
at least one parameter of the aircraft;
at least one environment parameter of the trajectory of the aircraft;
the at least one computing unit being configured, for each trajectory, to:
form a vector of input parameters comprising the input parameters associated with the trajectory;
extract at least one parameter from the trajectory;
the at least one computing unit being configured to train a supervised machine learning engine taking, at input, associations, for each trajectory respectively, between its vector of input parameters and at least one parameter of the trajectory.

12. A computer program product comprising program code instructions for executing the steps of the method as claimed in claim 1 when said program is executed on a computer.

13. A computer-implemented method receiving, at input, for a trajectory of an aircraft, a set of input parameters comprising:
at least one parameter of the aircraft;
at least one environment parameter of the trajectory of the aircraft;
said method comprising:
a step of forming, for the trajectory, a vector of input parameters comprising said input parameters;
a step of executing a supervised learning engine in order to compute, from the input vector, at least one parameter of the trajectory, said engine having been trained by a method as claimed in claim 1.

14. A computer program product comprising program code instructions for executing the steps of the method as claimed in claim 13 when said program is executed on a computer.

15. A system comprising:
at least one computing unit able to execute a supervised machine learning engine;
at least one input port able to receive, for a trajectory of an aircraft, a set of input parameters comprising:
at least one parameter of the aircraft;
at least one environment parameter of the trajectory of the aircraft;
the at least one computing unit being configured to:
form, for the trajectory, a vector of input parameters comprising said input parameters;
execute said supervised learning engine in order to compute, from the input vector, at least one parameter of the trajectory, said engine having been trained by a method as claimed in claim 1.

16. The system as claimed in claim 15, wherein the at least one computing unit is configured to use the at least one parameter of the trajectory as part of an air traffic flow management application.
